(19) United States
(12) Patent Application Publication
(10) Pub. No.: US 2010/0014311 A1
(43) Pub. Date: Jan. 21, 2010

(54) DEVICE FOR SIGNS

(75) Inventor: Daniele Danieli, Verona (IT)

Correspondence Address: ARENT FOX LLP, 1050 CONNECTICUT AVENUE, N.W., SUITE 400, WASHINGTON, DC, 20036, US

(73) Assignee: D-Due Divisione Laser S.r.l., Cerro Veronse, Verona (IT)

(21) Appl. No.: 12/305,904

(22) PCT Filed: Jun. 14, 2007
(86) PCT No.: PCT/EP07/05241

§ 371 Date: Dec. 19, 2008

(30) Foreign Application Priority Data
Jun. 22, 2006 (IT) MI2006A001203

(51) Int. Cl. F21V 7/22

(52) U.S. Cl. 362/606

(57) ABSTRACT

A device comprising the following parts; a light guiding plate in thermoplastic material; a source of light placed on at least one edge of the light guiding plate; a reflecting surface placed along the surface of the light guiding plate, a series of grooves being present on the lower surface, parallel to the light guiding plate edge on which there is the source of light; the grooves having: an hollow shape; the total groove surface, measured on the incision projections on the plate surface, comprised between 10% and 60% with respect to the plate surface; the width of each groove between 0.2 and 5 mm.

The present invention relates to plates, flat or curved, lighted by light sources placed on one or more edge lits, showing uniformly lit surfaces.

More specifically the present invention relates to plates made of thermoplastic polymers, preferably based on acrylic polymers, whose surfaces show an uniform lighting when lit by light sources placed on one or more edge lits.

The plates according to the present invention are usable for preparing LCD (liquid crystal display device) screens, preferably for luminous signs or displays, even of large sizes.

More specifically the invention refers to plates formed of methylmethacrylate copolymers with (meth)acrylic esters or (meth)acrylic acids, in particular methylmethacrylate/alkylacrylate copolymers, preferably ethyl acrylate, by which luminous signs can be made, which show as said, uniformly lit surfaces.

Devices formed of plates sheets having light sources on one or more edges are known in the prior art, and are used to uniformly lit luminous signs. These devices, also called “backlight units” or “edge light units”, are generally formed of a light guiding plate capable to diffuse the light on the device surfaces. At this purpose the plate can contain suitable additives, or have one or both surfaces satinized, or dot-print treated.

U.S. Pat. No. 5,584,556 describes a device to diffuse light comprising a light guiding plate, a light diffusing plate placed on the upper surface of the light guiding plate (looking at the device from the top), a reflecting surface placed on or adjacent to the lower surface of the light guiding plate, a light source placed on one or both the opposite sides of the light guiding plate (see the Figures of said patent). The lower surface of the light guiding plate has a series of small protrusions, or small cavities, or a series of grooves having rough surfaces. The figures illustrate that the protrusions, or the cavities, or the grooves are arranged according to lines which are parallel to the light guiding plate edge which is lit by the light source. This arrangement can also be in the form of dots aligned according to parallel lines, wherein the dot density increases as the distance from the light source increases. Furthermore from the figures it is noticed that when there are grooves on the light guiding plate, they generally become deeper, i.e. their depth increases, as the distance from the light source increases.

Patent application WO 02/101.448 describes a light guiding plate comprising a series of V-shaped grooves. They are therein defined horizontal and are perpendicular to the light source placed on one or both the opposite sides of the plate. The grooves are spaced and are placed along the light diffusion direction. Both the groove width and depth are gradually increased as the distance from the light source increases (see in particular FIGS. 11 and 12 of the patent application). Besides the horizontal grooves a second series of grooves, always V-shaped, perpendicular with respect to the previous ones, can be carried out, thus forming a reticule. The distance among the perpendicular grooves is reduced as their distance from the light source increases. According to this patent application a good plate light uniformity is obtained by using a series of grooves forming a reticule on the plate surface, as described above.

From an industrial point of view, it is requested that the devices used for luminous signs be easier to be manufactured and have a lower cost. A simplified industrial manufacturing process leads therefore to remarkable advantages in comparison with the known devices for luminous signs today on the market.

The need was felt to have available a “backlight unit” and/or “edge lit unit” device having the following combination of properties:
uniform lighting on the surfaces, even in case of broad ones, as those of the luminous signs, for example surfaces having a size of 500×700 mm, or 1,000×700 mm, or 1,000×1,800 mm, etc.;
simplified manufacturing process from an industrial point of view compared with those of the prior art.

The Applicant has surprisingly and unexpectedly found a device solving the above mentioned technical problem.

An object of the present invention is a “backlight unit” and/or “edge lit unit” device comprising the following parts:
a light guiding plate in thermoplastic material;
a light source placed on at least one edge of the light guiding plate;
a reflecting surface placed along one surface of the light guiding plate, here called lower surface, a series of grooves being present on said lower surface and arranged so as to be parallel to the light guiding plate edge on which there is the light source;
the grooves having:
   a hollow shape;
   the total groove surface, measured on the groove projections on the plate surface, comprised between 10% and 60%, preferably 15%-40%, with respect to the plate surface;
   the groove width is comprised between 0.2 and 5 mm, preferably between 0.5 mm and 2 mm.

In the device of the present invention instead of a light source, two light sources are preferably used placed on the parallel, edges of the light guiding plate. Light sources placed on all the sides of the light guiding plate can also be used.

The light guiding plate can have very reduced sizes, such as the A4 format, up to very large sizes, for example a width of 2 m and length as desired, i.e. non critical, also up to 10 m, respectively. Preferably the light guiding plate has sizes 500 (width)×700 mm (length), or 700×1,000 mm, or 1,000×1,800 mm, respectively.

The grooves have generally a rough surface. Generally the grooves have the same shape.

Generally the groove depth can range from 50 μm to 2 mm.

Preferably the groove density on the plate surface increases by increasing the distance from the light source. On the plate surface bearing the grooves (lower surface) the groove width can be also variable.

By groove density it is meant the number of grooves/unit surface.

The reflecting surface is generally made of any material that reflects light, for example a white surface can be used. For example thermoplastic polymers, for example foam PVC, as Forex®; metal sheets, in particular an aluminum sheet, or aluminium composites, as Dibond®, can be used as reflecting surface.

According to another embodiment of the present invention in place of the reflecting surface a transparent thermoplastic material sheet can be used. In this way advertising signs having both surfaces lit are obtained.

Optionally on the lower surface of the light guiding plate also grooves perpendicular to the parallel grooves as defined above can also be present. The perpendicular grooves can also be regularly spaced.

The polymeric thermoplastic material of which the light guiding plate is made, can for example be a (meth)acrylic (co polymer, polyethylenterephthalate, polyethylenterephthalate modified with a glycol, such as for example diethylenglycol, butandiol, hexanediol and 1,4-cyclohexan dimethanol. Mixtures of various thermoplastic materials can also be used. In particular the (meth)acrylic thermoplastic (co)polymer can be formed of an alkyl(meth)acrylate homopolymer or of a copolymer derived from an alkyl(meth)acrylate with at least one monomer having one or more ethylene type unsaturations. As alkyl(meth)acrylate, those wherein the alkyl has from 1 to 8 carbon atoms, preferably from 1 to 4 carbon atoms, for example methyl-, ethyl-, propyl-, isopropyl- and butyl(meth)acrylate, can be mentioned. A particularly preferred monomer is methyl methacrylate. Preferably the thermoplastic polymer is formed of methyl methacrylate homopolymers or copolymers of methylmethacrylate with (meth)acrylic esters or (meth)acrylic acids, in particular methylmethacrylate/alkyl-acrylate copolymers, preferably ethyl acrylate. The (meth)-acrylic thermoplastic (co)polymer comprises from 70% to 100% by weight of alkyl methacrylate and from 0% to 30% by weight, preferably from 3% to 10% by weight, of one or more comonomers containing one or more ethylene unsaturations. The monomers containing one or more ethylene unsaturations are for example selected from C₁-C₈ alkyl-acrylates, styrene, styrene substituted, acrylonitrile, methacrylonitrile, C₁-C₈ alkyl methacrylates different from the alkyl methacrylate used as main comonomer, hydroxyalkyl acrylates and methacrylates, alkoxyalkyl or aryloxyalkyl acrylates and methacrylates wherein the alkyl group has from 1 to 4 carbon atoms, acrylamide, methacrylamide, acrylic acid, methacrylic acid, maleimides and dimethacrylates of C₁-C₄ alkylen glycol. The acrylic copolymers can be obtained by the known processes, for example by suspension or mass polymerization. The polymerization takes place in the presence of a chain transfer agent, as for example di-unsaturated monocyclic terpenes and monounsaturated bicyclic terpenes, as for example terpinolene; mercaptanes, as tert-dodecyl mercaptane.

The light guiding plate according to the present invention can be obtained by extrusion, casting, or compression molding.

The light guiding plate edges are preferably polished according to known techniques.

On one or more edges of the light guiding plate of the present invention, on which the light source is not positioned, a reflecting film can be placed, for example a polyester film, in particular a Scotch 3M® polyester tape 850 film; a metallic film, for example an aluminium film, etc.

Optionally the thermoplastic polymer of the light guiding plate can contain light diffusing fillers. The fillers can be polymeric and/or inorganic. The polymeric fillers, for example PTFE, have average particle sizes between 0.1 and 200 micron, preferably from 0.1 to 50 micron, more preferably from 1 to 15 micron. The amount of organic fillers is between 5 and 1,000 ppm, preferably from 100 to 200 ppm. The inorganic fillers, for example barium sulphate, have average particle sizes between 0.1 and 50 micron, preferably between 0.5 and 10 micron. Their amount by weight is in the range 0.01%-2%, preferably 0.1%-0.8%, still more preferably 0.1%-0.6%.

The surface of the light guiding plate opposite to that bearing grooves can contain grooves or it can be matted or smooth.

The grooves on the surface of the light guiding plate can be obtained with the equipments commonly available in the art, for example by milling or laser incisions.

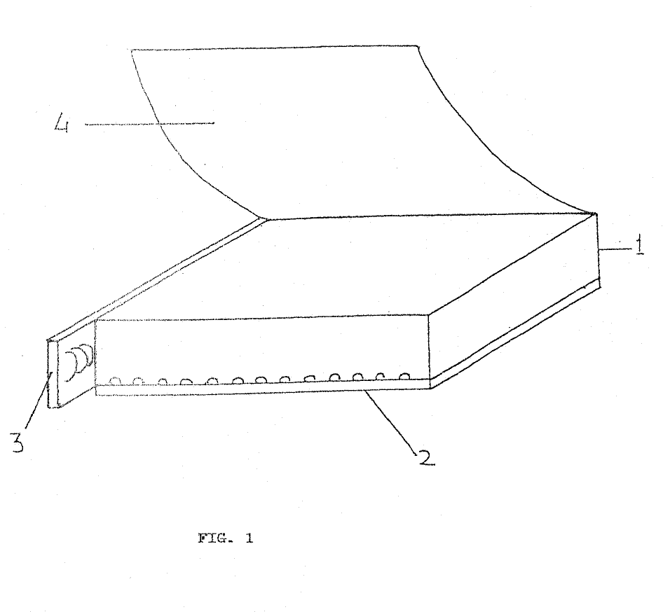

In FIG. 1 a preferred embodiment of the device according to the present invention is represented. (1) indicates the light guiding plate bearing on its lower surface the grooves (incisions); (2) is the reflecting film; (3) is the light source, shown in the figure by a series of LED, (4) is the sheet which bears the advertising message. The LEDs (3) are generally placed in the direction of the plate length, as shown, in FIG. 1.

It is a further object of the present invention luminous signs and LCD screens comprising the “backlight unit” or “edge lit unit” device according to the present invention.

It has been surprisingly and unexpectedly found by the Applicant that with the device of the present invention it is possible to obtain an uniform lighting of a remarkable intensity on the device surface, without the need of diffusing plates that are incorporated in the devices of the prior art. Furthermore this result is obtained without using grooves having particular shapes or grooves perpendicular each other to form reticule, as in the prior art.

The device of the present invention represents therefore a remarkable simplification of the known embodiments on the market and of the prior art.

The following Examples illustrate the invention and do not limit the application scope thereof.

### EXAMPLES

The light system used is formed of two LED strips, placed on two opposite edges of the light guiding plate, parallel to the grooves, said LEDs having an overall power of 56 W.

### Determination of the Light Intensity Diffused on the Free Surface of the Light Guiding Plate

A luxmeter RS 180-7133 model is used.

The luxmeter is moved along a line which is perpendicular to the two lit edges. The light intensity at fixed positions on said line is taken.

### Example 1

### Measurement of the Luminous Intensity on the Free Surface of a “Backlight Unit” Device According to the Present Invention

The used, device consists of a light guiding plate having 500 (width)×700 (length) mm and 10 mm thickness sizes, having grooves on the lower surface of the plate. Said grooves have an average width of 1 mm, a depth of 200 μm and are made by using a conventional laser device. The grooves are spaced in such a way that the total area, measured from the projections of the grooves on the plate surface is 28%, with respect to the total surface of the side of the plate. The grooves show a rough surface.

As reflecting surface a white Forex® (foam PVC) plate is used.

By using the above described method the intensities of light reported in Table 1 have been measured.

### Example 1A

### Preparation of a Sign by Using the “Backlight Unit” Device of the Example 1

On the free surface of the “backlight unit” device prepared in the Example 1 a Duratrans® sheet bearing an advertising message in the form of a serigraph is positioned. The applied sheet has the same surface as the device.

The so prepared panel appears uniformly lit and the intensity of light is well evident even in daylight conditions.

### Example 2

### Comparative

### Positioning of a Diffusing Plate on the Free Surface of a “Backlight Unit” Device According to the Present Invention and Determination of the Intensity of Light

On the free surface of the light guiding plate of a device equal to that used in the Example 1 a diffusing plate in acrylic material is positioned. The plate has a transmittance equal to 88-90% and a haze equal to 98%, measured with Hazemeter (according to ASTM D 1003 standard for both the determinations).

The light intensity values are reported in Table 2.

The data reported in the Table show that the light intensity values determined at the various points of the device surface, even if rather uniform, are lower than those of the Example 1.

### Example 2A

### Comparative

### Preparation of a Sign by Using the “Backlight Unit” Device of the Example 2 Comparative

On the free surface of the “backlight unit” device prepared in the Example 1 a Duratrans® sheet bearing an advertising message in the form of a serigraph is positioned as described in the Example 1A.

The so prepared advertising sign is visually compared with that of the Example 1A. The light intensity is lower than that of the panel of the Example 1A.

### Example 3

### Comparative

### Light Intensity Determination on the Free Surface of a “Backlight Unit” Device Wherein the Total Area of the Projections of the Grooves on the Plate Surface is Equal to 70% with Respect to the Surface Area of the Side of the Plate

The device is formed of a light guiding plate having 500 (width)×700 (length) mm and 10 mm thickness sizes. On the lower surface of the plate grooves are made by using a laser equipment. The thus formed grooves have an average width of 1 mm, depth of 200 μm. The grooves are spaced each from the other so that the total area, measured from the projections of the grooves on the plate surface, with respect to the total surface of the plate side, is equal to 70%. The grooves show a rough surface.

As reflecting surface a white Forex® (foam PVC) plate is applied.

By using the above described method the light intensities reported in Table 3 have been measured.

Table 3 shows that, when the global area of the projections of the hollow incisions on the plate surface exceeds 60%, the light intensity distribution on the plate surface is no longer uniform. In fact it was found that those parts of the plate surface that were adjacent to the light sources were more intensely lit.

TABLE 1

| | Distance from the light guiding plate edge (cm) | | | | | | |
|---|---|---|---|---|---|---|---|
| | 5 | 15 | 20 | 25 | 30 | 35 | 45 |
| Lux | 1,600 | 1,610 | 1,620 | 1,600 | 1,620 | 1,620 | 1,610 |

TABLE 2

| | Distance from the light guiding plate edge (cm) | | | | | | |
|---|---|---|---|---|---|---|---|
| | 5 | 15 | 20 | 25 | 30 | 35 | 45 |
| Lux | 1,300 | 1,350 | 1,320 | 1,300 | 1,330 | 1,360 | 1,310 |

TABLE 3

| | Distance from the light guiding plate edge (cm) | | | | | | |
|---|---|---|---|---|---|---|---|
| | 5 | 15 | 20 | 25 | 30 | 35 | 45 |
| Lux | 1,800 | 1,400 | 900 | 600 | 1,100 | 1,530 | 1,850 |

1. A “backlight unit” device comprising the following parts:
a light guiding plate in thermoplastic material; a source of light placed on at least one edge of the light guiding plate;
a reflecting surface placed along one surface of the light guiding plate, herein called lower, a series of grooves being present on said inferior surface, and arranged so as to be parallel to the light guiding plate edge on which there is placed the light source;
the grooves having:
an hollow shape;
the total groove surface, measured on the groove projections on the plate surface, is comprised between 10% and 60%, preferably 15%-40%, with respect to the plate surface;
the groove width is comprised between 0.2 and 5 mm, preferably between 0.5 mm and 2 mm.

2. A device according to claim 1, wherein there are two light sources placed on the parallel edges of the light guiding plate.

3. A device according to claim 1, wherein the sizes of the light guiding plate vary from the A4 format, up to a width of 2 m, the length being as desired.

4. A device according to claim 3, wherein the light guiding plate has 500 (width)×700 mm (length), or 700×1,000 mm, or 1,000×1,800 mm sizes.

5. A device according to claim 1, wherein the grooves have a rough surface.

6. A device according to claim 1, wherein the grooves have a depth ranging from 50 μm to 2 mm.

7. A device according to claim 1, wherein the groove density increases by increasing the distance from the light source.

8. A device according to claim 1, wherein the groove width is variable.

9. A device according to claim 1, wherein the reflecting surface is formed of materials selected from thermoplastic polymers, metal sheets, preferably aluminum, or aluminum composites.

10. A device according to claim 1, wherein in place of the reflecting surface a plate in transparent thermoplastic material is used.

11. A device according to claim 1, wherein on the lower surface of the light guiding plate there are grooves perpendicular to the parallel grooves.

12. A device according to claim 1, wherein the thermoplastic material of the light guiding plate is a (meth)-acrylic (co)polymer, polyuethylenterephthalate, poly-ethyleneterephthalate modified with a glycol, or their mixtures.

13. A device according to claim 12, wherein the (meth)acrylic (co)polymer is an alkyl(meth)acrylate homopolymer or a copolymer derived from an alkyl(meth)acrylate with at least one monomer having one or more ethylene type unsaturations.

14. A device according to claim 13, wherein the thermoplastic polymer is selected from methyl methacrylate homo-polymers, copolymers of methylmethacrylate with (meth)-acrylic esters or (meth)acrylic acids.

15. A device according to claim 14, wherein the (meth)-acrylic (co)polymer comprises from 70% to 100% by weight of alkyl methacrylate and from 0% to 130% by weight of one or more comonomers selected from C₁-C₈ alkyl-acrylates, styrene, styrene substituted, acryilonitrile, methacrylonitrile, C₁-C₈ alkyl methacrylates different from the alkyl methacrylate used as main comonomer, hydroxyalkyl acrylates and methacrylates, alkoxyalkyl or aryloxyalkyl acrylates and methacrylates wherein the alkyl group has from 1 to 4 carbon atoms, acrylamide, methacrylamide, acrylic acid, methacrylic acid, maleimides and dimethacrylates of C₁-C₄ alkylen glycol.

16. A device according to claim 15, wherein the light guiding plate edges are polished.

17. A device according to claim 16, wherein on the edges of the light guiding plate where the source of light is not positioned, a reflecting film is placed.

18. A device according to claim 17, wherein the light guiding plate contains fillers diffusing light, of polymeric or inorganic type.

19. A device according to claim 18, wherein the polymeric fillers have average sizes between 0.1 and 200 micron, preferably from 0.1 to 50 micron, more preferably from 1 to 15 micron.

20. A device according to claim 19, wherein the amount of organic fillers is between 5 and 1,000 ppm, preferably from 100 to 200 ppm.

21. A device according to claim 18, wherein the inorganic fillers have average sizes between 0.1 and 50 micron, preferably between 0.5 and 10 micron.

22. A device according to claim 21, wherein the amount by weight of the inorganic fillers is in the range 0.01%-2%, preferably 0.1%-0.8%, still more preferably 0.1%-0.6%.

23. A device according to claim 1, wherein the surface of the light guiding plate opposite to that bearing grooves can contain grooves or it can be matted or smooth.

24. Luminous signs and LCD screens comprising the devices according to claim 1.
